(19) United States
(12) Patent Application Publication
(10) Pub. No.: US 2013/0086163 A1
(43) Pub. Date: Apr. 4, 2013

(54) Healthcare Information System Interface Supporting Social Media and Related Applications

(71) Applicant: Robert A. Neff, Penn Valley, PA (US)

(72) Inventor: Robert A. Neff, Penn Valley, PA (US)

(73) Assignee: SIEMENS MEDICAL SOLUTIONS USA, INC., Malvern, PA (US)

(21) Appl. No.: 13/292,202

(22) Filed: Nov. 9, 2011

Related U.S. Application Data
(60) Provisional application No. 61/542,884, filed on Oct. 4, 2011.

(51) Int. Cl. G06F 15/16

(52) U.S. Cl. 709/204

(57) ABSTRACT

A system automatically securely shares patient information via social media networks. The system comprises at least one repository of information including, a patient profile including, patient name, data identifying information items shareable via at least one social media network and patient contact information and communication information supporting compatible communication with at least one social media network. A configuration processor enables the profile to be established for the patient in response to user data entry. A communication processor automatically, uses the communication information in generating at least one message for sharing at least one of the shareable information items and communicates the at least one generated message to a social media network. The at least one message is compatible with a social media network.

### RELATED APPLICATIONS

This is a non-provisional application of provisional application Ser. No. 61/542,884 filed Oct. 4, 2011, by R. A. Neff.

### FIELD OF THE INVENTION

This invention concerns a system for secure automatic sharing of shareable information items identified in an established patient profile via social media networks.

### BACKGROUND OF THE INVENTION

Hospital information systems track real time data concerning the condition and location of people while they are in the hospital and receiving medical care. While this data is highly confidential and guarded as HIPPA (Health Insurance Portability and Accountability Act) controlled data, in many circumstances the patients would like to share this information with friends and family automatically. Known systems typically lack an automatic means for this, and patients (or their family) share patient status information manually with their friends and contacts in their social media networks. A system according to invention principles addresses this deficiency and related problems.

### SUMMARY OF THE INVENTION

A system together with user applications is interfaced with a healthcare information system (HIS) and automatically securely shares, via social media, patient related medical data, in response to a patient profile established in response to patient command. A system automatically securely shares patient information via social media networks. The system comprises at least one repository of information including, a patient profile including, patient name, data identifying information items shareable via at least one social media network and patient contact information and communication information supporting compatible communication with at least one social media network. A configuration processor enables the profile to be established for the patient in response to user data entry. A communication processor automatically, uses the communication information in generating at least one message for sharing at least one of the shareable information items and communicates at least one generated message to a social media network. The communicated messages are compatible with a social media network.

### BRIEF DESCRIPTION OF THE DRAWING

FIG. 1 shows a system for secure automatic sharing of patient information via social media networks and for processing patient information acquired via a social media network, according to invention principles.

FIG. 2 shows a social media interface including a patient module and general settings, log, and third party adapter modules, according to invention principles.

FIG. 3 shows a repository of information identifying patient events to be sent via a social media interface, according to invention principles.

FIG. 4 shows a repository of information identifying social network access and login information, according to invention principles.

FIG. 5 shows a repository of information identifying data accessible and used by third party applications, according to invention principles.

FIG. 6 shows a flowchart of a process performed by the system for secure automatic sharing of patient information via social media networks and for processing patient information acquired via a social media network, according to invention principles.

FIG. 7 shows a flowchart of a process performed by an executable application for processing patient information acquired via a social media network enabling providing goods to a patient, according to invention principles.

### DETAILED DESCRIPTION OF THE INVENTION

A system is integrated with a healthcare information system (HIS) and enables a patient to securely share medical information related to the patient (or a selected subset of the medical information) via an interface to social media. A variety of different social media applications may be provided and used to take advantage of the patient data. The system includes an interface and user operable executable applications to make use of the patient interfaced information. HIS applications operate using multiple different communication and data formatting protocols and standards including Helathlevel7 (HL7) and ADT (Admission, Discharge, and Transfer) messaging formats. In one embodiment, when a patient is indicated as being admitted or discharged in an HIS, a message is sent to the social media networks with information identifying the discharge or admission. The receiving social media network posts a message or communicates a message to a predetermined list of recipients, stating that the patient has been admitted or discharged. The receiving social media network may include an application which takes advantage of this information. For example, an application may offer to send flowers, through a third party partner to the patient in the hospital using a patient social media interface profile. The system security application in response to patient command allows different levels of information sharing (or excludes sharing) to patient identified particular persons or institutions and supports login to respective associated social media networks with which the information is to be shared.

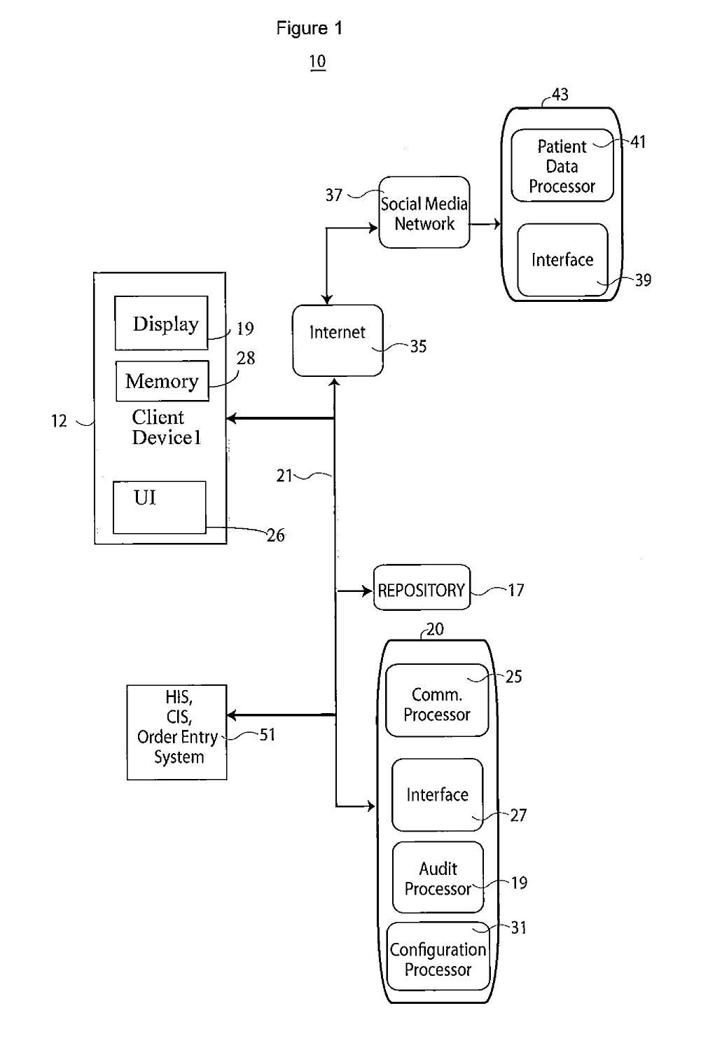

FIG. 1 shows system 10 for secure automatic sharing of patient information via social media networks and includes an application for processing patient information acquired via a social media network. System 10 includes one or more processing devices on network 21 (e.g., workstations, computers or portable devices such as notebooks, Personal Digital Assistants, phones) 12 that individually include a user interface 26 enabling user interaction with a Graphical User Interface (GUI) and display 19 supporting GUI and medical data, image and administrative information presentation in response to predetermined user (e.g., physician, nurse administrator) specific preferences. System 10 also includes at least one repository 17, server 20 and HIS 51 (including ADT, clinical information, order entry and other applications) intercommunicating via network 21. Server 20 includes communication processor 25, configuration processor 31, interface 27 and audit processor 19. Server 20 communicates via network 21 and Internet 35 (or via Internet 35 directly, connection not shown to preserve drawing clarity) with social media network 37 interacting with application 43. Application 43 includes interface 39 and patient data processor 41.

Interface 27 receives messages from HIS 51. At least one repository 17 comprises information including, a patient profile including, patient name, data identifying information items shareable via at least one social media network 37 and patient contact information and communication information supporting compatible communication with at least one social media network 37. Configuration processor 31 enables the profile to be established for the patient in response to user data entry. Communication processor 25 automatically, uses the communication information in generating at least one message for sharing at least one of the shareable information items and communicates the at least one generated message to social media network 37. The at least one message is compatible with social media network 37. Audit processor 19 records data identifying messages communicated to social media network 37.

Executable application 43 processes patient information acquired via social media network 37. Application 43 includes interface 39 for receiving data identifying a patient name and location of the patient in a hospital via social media network 37. Patient data processor 41 automatically, incorporates an image element in a user interface display image displayable via the social media network. The image element enables a user to select a goods item to be sent to the patient. In response to user activation of the image element and receiving data identifying the goods item, processor 41 communicates a message to a destination for initiating sending the goods item to the patient.

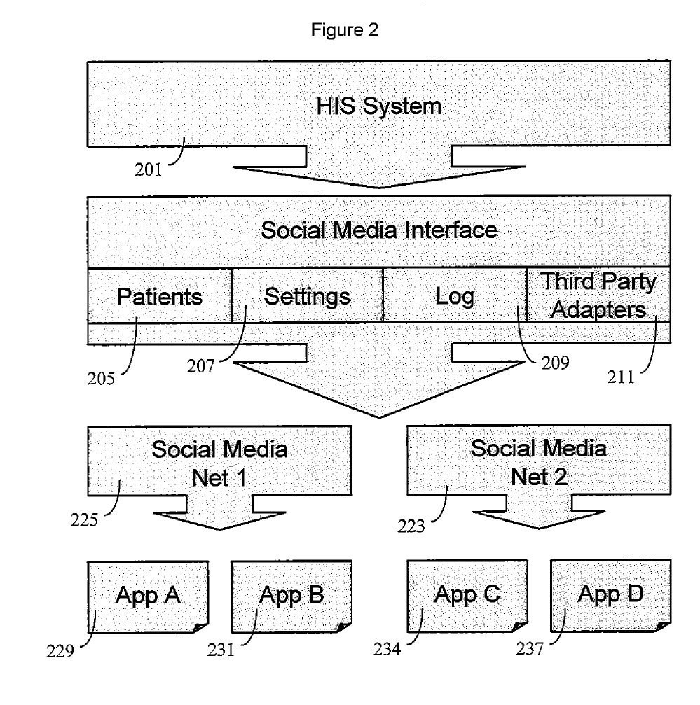

FIG. 2 shows a social media interface 203 supporting bidirectional communication of social media networks 225 and 223 with HIS 201 (e.g., HIS 51 and server 20, FIG. 1, for example). Interface 203 includes patient module 205, settings module 207, log module 209, and third party adapter modules 211. Social media network 225 interacts with applications 229 and 231 and social media network 223 interacts with applications 234 and 237. Patient module 205 enables configuration and setup of a patient profile in the system if a patient elects to make use of interface 203. In response to a patient electing, substantially at the time of their admission (or during update or establishment of a patient electronic medical record (EMR)), to make use of the system, an entry for the patient is made in patient module 205. This module includes patient profile information detailing patient accounts in various different socials networks, data identifying types of events and information that is to be communicated to selected recipients via the social networks and data identifying information accessible by third party applications.

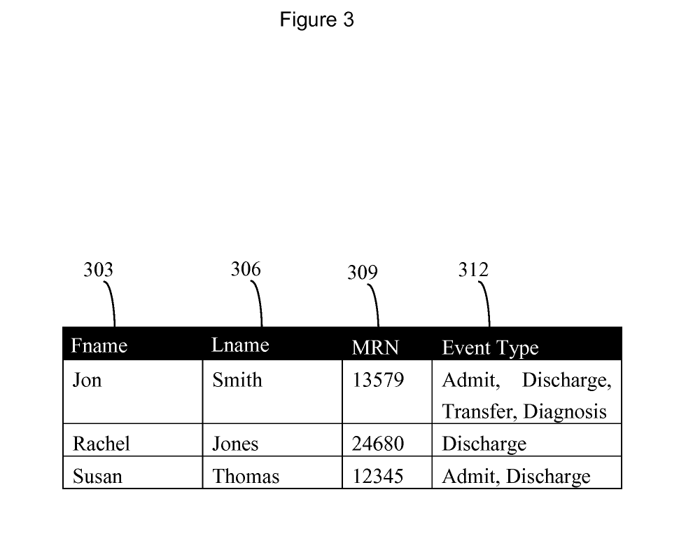

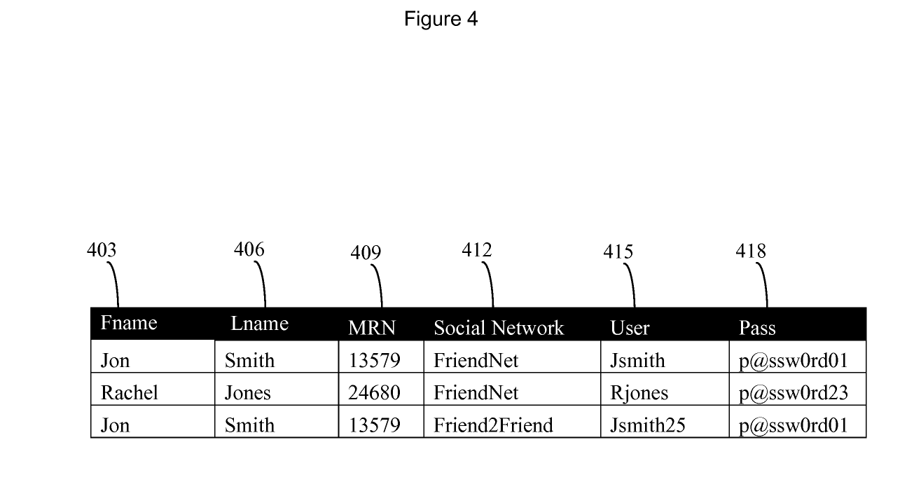

FIG. 4 shows a repository of patient profile information stored in module 205 identifying patient social network access and login information detailing patient accounts in various different socials networks which the patient may want to interface. Specifically, the repository associates patient first and last names 403, 406 with medical record number 409, social media network identifier 412, userid 415 and password 418. FIG. 3 shows a repository of patient profile information stored in module 205 identifying patient events to be communicated via social media interface 203 to selected recipients via the social networks. For example, exclusively admissions and discharges, transfers or a diagnosis, may be selected to be communicated to the social network recipients or excluded from sharing. The repository associates patient first and last names 303, 306 with medical record number 309 and event type identification or identifier 312 such as of admission, discharge, transfer and diagnosis events, for example.

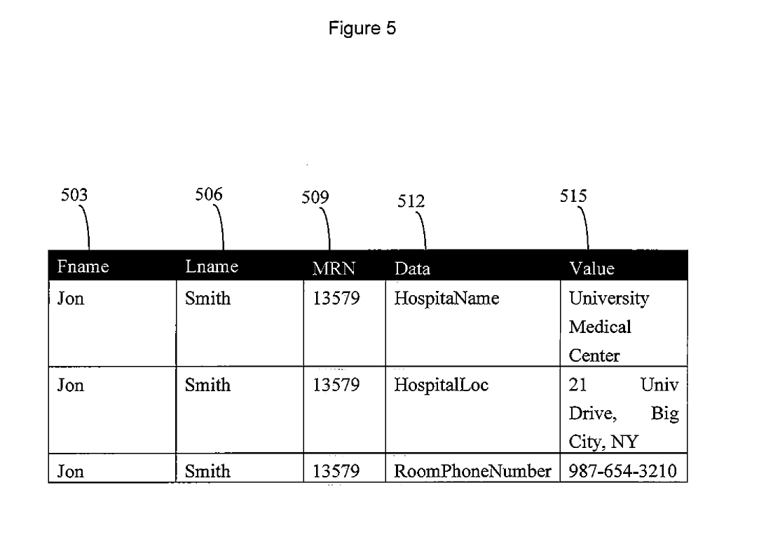

FIG. 5 shows a repository of information stored in module 205 identifying data accessible and used by third party applications. This information includes patient address in the hospital, phone number, and other hospital related stay information which is useful for third party systems. This information is marked and securely provided to internal social media network associated systems not external users, for processing in response to third party application requests. An example of this is the address of a hospital and room number. This is made available to a third party application which sends physical items (flowers, cards, food items, for example) to the hospital patient. Specifically, the repository associates patient first and last names 503, 506 with medical record number 509, patient contact data item identifier 512 and corresponding contact data item information such as hospital name, address, patient room identifier, patient phone number 515.

General settings module 207 (FIG. 2) stores general information indicating how interface 203 is configured. Examples of this information include types of details affecting the operation of the interface. For example, the frequency at which updates can be sent to third party systems, language to be used for the external messages, static information about a hospital, like “SendingSystemName”. Log module 209 records a log of actions taken using the system. Individual messages that are received by the system and individual messages that are sent out of the system are logged in a log module database. The log records are available to be viewed and stored through different methods.

Third party adapter module 211 manages interfacing and communication with Social Networks 223 and 225. An individual social network typically employs media network specific communication protocols and formats that differ from those used by other social media networks. A third party adapter application in module 211 adaptively supports communication with a corresponding respective social media network. An adapter application processes, collates, formats and converts normalized information as needed for compatible communication with a social network in response to predetermined information determining translation of the normalized information to a format to be compatible with the social network. The adapter communicates translated information in a compatible message format to the Social Network using a selected communication protocol. A social media network interface does not need to be changed to accommodate this information.

Applications 229, 231, 234 and 237 (FIG. 2) are provided by a third party vendor or a social media network and are advantageously integrated with social media networks 225 and 223 and the system. An example of application comprises a Flower Delivery application comprising part of a social network called Friend2Friend, for example. When the Friend2Friend network receives a message from the system via interface 203 that patient Jon Smith has been admitted to a hospital, the social media network incorporates an icon on a display image presenting recent news concerning Jon Smith. In response to a friend clicking the icon, a flower ordering menu is presented associated with a shop that delivers flowers directly to the patient at the hospital in a user friendly streamlined operation. Multiple different applications are able to advantageously use the system and patient profile information. For example, a “call” icon is displayed which routes phone calls directly to a patient in a hospital room. The system enables a wide variety of different social media network applications to be generated and take advantage of interface 203.

In operation, in response to a patient being indicated in an HIS as being admitted, message data is communicated to Social Network Interface System 203. The message data includes data acquired from a profile of the patient in module 205 enabling login to social media networks 223, 225 identified in the patient profile and including data identifying event type preferences comprising event types that are to be forwarded to predetermined recipients on the network (or made publicly available on the network). Log module 209 records time, date, content, source and destination of the message. In response to occurrence of an event identified in the patient profile such as transfer, discharge, completion of a diagnosis or treatment stage, for example, interface 203 generates and communicates a message to social media networks 223, 225. Social media networks 223, 225 post the message data content on a public wall and provides the content data to social network applications, 229, 231, 234 and 237 that advantageously use this data. An application uses this data, for example enabling “Friends” to send flowers, food items, goods items, cards, for example, to the patient through a simple process. Alternatively, social media networks 223, 225 send the message data content to patient selected recipients and applications identified in the patient profile.

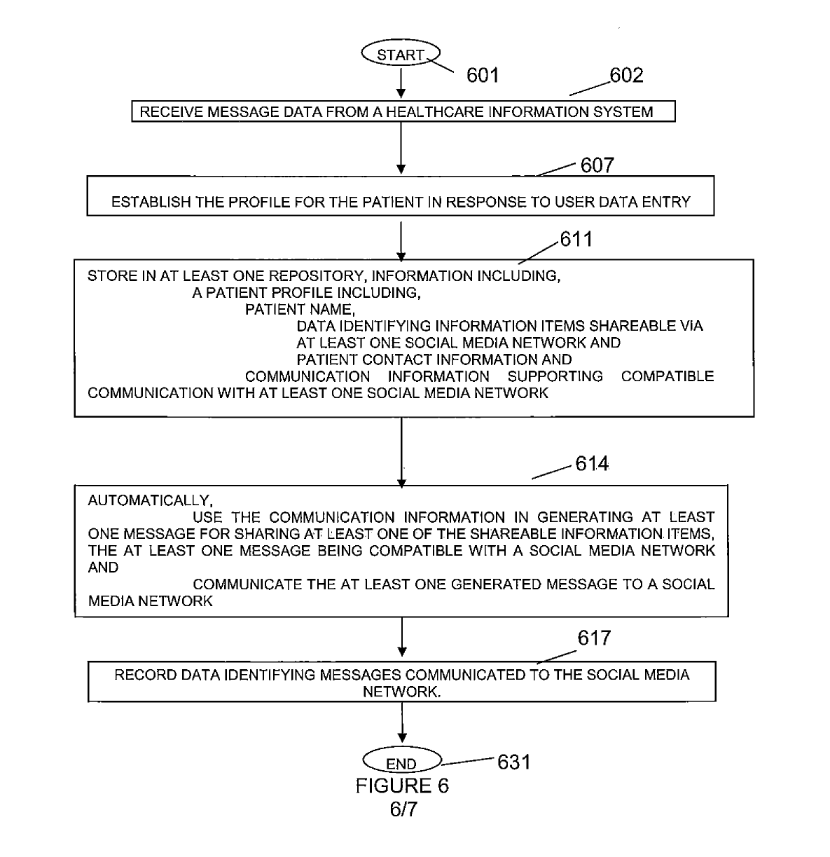

FIG. 6 shows a flowchart of a process performed by system 10 (FIG. 1) for secure automatic sharing of patient information via social media networks and for processing patient information acquired via a social media network (e.g., Facebook™). Interface 27 in step 602 following the start at step 601 receives message data from healthcare information system 51. In step 607, configuration processor 31 establishes a profile for the patient including data identifying events triggering communication with the social media network, in response to user data entry by the patient and/or a healthcare organization worker and the received message data. The patient profile includes an identifier of the patient and data identifying, permissible types of information to be communicated to the social media network, specific recipient persons, a social media network and the patient userid and password on the social media network and specific recipient executable applications. In step 611 interface 27 stores in at least one repository 17, information including, a patient profile including, patient name, data identifying information items shareable via at least one social media network and patient contact information and communication information supporting compatible communication with at least one social media network.

In step 614 communication processor 25 automatically, uses the communication information in generating at least one message to be compatible with a social media network for sharing at least one of the shareable information items and communicates the at least one generated message to the social media network. Communication processor 25 communicates the at least one generated message to the social media network in response to receiving message data from the healthcare information system identifying a trigger event indicated in the profile. Communication processor 25 communicates the at least one generated message including at least one of the types of permissible information, excluding non-permissible information, to the social media network for providing the message data exclusively to the recipient persons and a specific recipient executable application via the social media network The permissible types of information include patient hospital address, location of the patient in the hospital and patient telephone number while in hospital. Processor 25 communicates the at least one generated message in response to predetermined information indicating at least one of, (a) a frequency at which messages concerning a particular patient are to be communicated to the social media network and (b) language of a communication. In step 617 audit processor 19 records data identifying messages communicated to the social media network. The process of FIG. 6 terminates at step 631.

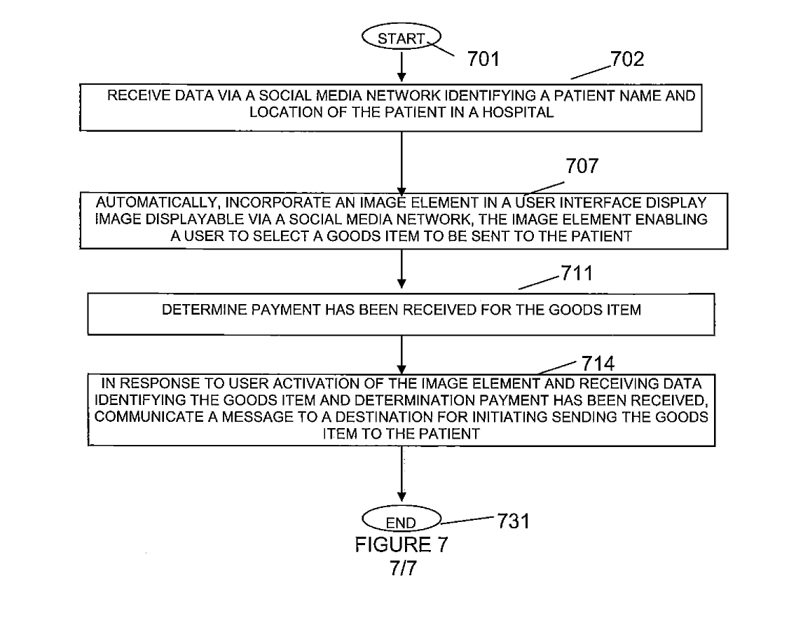

FIG. 7 shows a flowchart of a process performed by an executable application for processing patient information acquired via a social media network enabling providing goods to a patient. Interface 39 in the application (e.g., application 229 FIG. 2) in step 702 following the start at step 701 receives data identifying a patient name and location of the patient in a hospital via a social media network. Patient processor 41 in step 707 automatically incorporates an image element in a user interface display image displayable via a social media network. The image element enables a user to select a goods item to be sent to the patient. The patient processor in step 711 determines payment has been received for the goods item and in step 714 in response to user activation of the image element and receiving data identifying the goods item and the determination, communicates a message to a destination for initiating sending the goods item to the patient. The goods item comprises at least one of, (a) a food item, (b) flowers and (c) a card. The process of FIG. 7 terminates at step 731.

A configuration processor enables a patient to establish a profile in response to user (patient and/or healthcare worker) data entry and comprises an application responding to user data entry to create the profile e.g. select types of events to send and when including address, phone no., email address, for example. A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a user interface processor and enabling user interaction with a processor or other device and associated data acquisition and processing functions.

The UI also includes an executable procedure or executable application. The executable procedure or executable application conditions the user interface processor to generate signals representing the UI display images. These signals are supplied to a display device which displays the image for viewing by the user. The executable procedure or executable application further receives signals from user input devices, such as a keyboard, mouse, microphone, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of FIGS. 1-7 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system is integrated with a healthcare information system (HIS) and enables a patient to securely share a selected subset of medical information via an interface to social media networks with selected recipients and applications supporting providing the patient with goods, in response to predetermined events (e.g. hospital admission). Further, the processes and applications may, in alternative embodiments, be located on one or more (e.g., distributed) processing devices on a network linking the units of FIG. 1. Any of the functions and steps provided in FIGS. 1-7 may be implemented in hardware, software or a combination of both.

What is claimed is:

1. A system for secure automatic sharing of patient information via social media networks, comprising:
at least one repository of information including,
a patient profile including,
patient name,
data identifying information items shareable via at least one social media network and
patient contact information and
communication information supporting compatible communication with at least one social media network;
a configuration processor enabling said profile to be established for said patient in response to user data entry; and
a communication processor for automatically,
using the communication information in generating at least one message for sharing at least one of the shareable information items, said at least one message being compatible with a social media network and
communicating the at least one generated message to a social media network.

2. A system according to claim 1, including
an interface for receiving message data from a healthcare information system and wherein
said patient profile includes data identifying events triggering communication with said social media network and
said communication processor communicates said at least one generated message to said social media network in response to receiving message data from said healthcare information system identifying a trigger event indicated in said profile.

3. A system according to claim 2, wherein
said patient profile includes data identifying permissible types of information to be communicated to said social media network and
said communication processor communicates said at least one generated message including at least one of the types of permissible information excluding non-permissible information to said social media network.

4. A system according to claim 1, wherein
said patient profile includes an identifier of said patient and data identifying specific recipient persons and
said communication processor communicates said at least one generated message to said social media network for providing the message data exclusively to said recipient persons.

5. A system according to claim 1, wherein
said patient profile includes data identifying permissible types of information to be communicated to said social media network and
said communication processor communicates said at least one generated message including at least one of the types of permissible information excluding non-permissible information to said social' media network.

6. A system according to claim 5, wherein
said permissible types of information include patient hospital address, location of the patient in the hospital and patient telephone number while in hospital.

7. A system according to claim 1, wherein
said patient profile includes data identifying a social media network and the patient userid and password on the social media network.

8. A system according to claim 1, wherein
said patient profile includes data identifying a specific recipient executable application and
said communication processor communicates said at least one generated message to a specific recipient executable application via said social media network.

9. A system according to claim 1, including
an audit processor for recording data identifying messages communicated to said social media network.

10. A system according to claim 1, wherein
said communication processor communicates said at least one generated message in response to predetermined information indicating at least one of, (a) a frequency at which messages concerning a particular patient are to be communicated to said social media network and (b) language of a communication.

11. A system according to claim 1, wherein
said social media network comprises Facebook™.

12. A system according to claim 1, wherein
said user data entry comprises data entry by at least one of (a) said patient and (b) a healthcare organization worker.

13. An executable application for processing patient information acquired via a social media network, comprising:
an interface for receiving data via a social media network, said data identifying a patient name and location of the patient in a hospital; and
a patient data processor for automatically,
incorporating an image element in a user interface display image displayable via a social media network, said image element enabling a user to select a goods item to be sent to said patient and
in response to user activation of said image element and receiving data identifying said goods item, communicating a message to a destination for initiating sending said goods item to said patient.

14. A system according to claim 13 wherein
said goods item comprises at least one of, (a) a food item, (b) flowers and (c) a card.

15. A system according to claim 13, wherein
said patient data processor,
determines payment has been received for said goods item and
communicates said message to said destination in response to said determination.

16. A method for secure automatic sharing of patient information via social media networks, comprising the activities of:
storing in at least one repository, information including,
a patient profile including,
patient name,
data identifying information items shareable via at least one social media network and
patient contact information and
communication information supporting compatible communication with at least one social media network;
establishing said profile for said patient in response to user data entry; and
automatically,
using the communication information in generating at least one message for sharing at least one of the shareable information items, said at least one message being compatible with a social media network and
communicating the at least one generated message to at least one social media network.

17. A method for processing patient information acquired via a social media network, comprising the activities of:
receiving data via a social media network, said data identifying a patient name and location of the patient in a hospital;
automatically, incorporating an image element in a user interface display image displayable via a social media network, said image element enabling a user to select a goods item to be sent to said patient; and
in response to user activation of said image element and receiving data identifying said goods item, communicating a message to a destination for initiating sending said goods item to said patient.
